(19) United States
(12) Patent Application Publication
(10) Pub. No.: US 2021/0203188 A1
(43) Pub. Date: Jul. 1, 2021

(54) AN ELECTRIC POWER SYSTEM AND A METHOD OF TRANSMITTING ELECTRIC POWER FROM A POWER SOURCE TO A DEVICE VIA A SINGLE-WIRE ELECTRIC WIRE

(71) Applicant: FOLQUER HOLDINGS LIMITED, Nicosia (CY)

(72) Inventors: Andrey Borisovich TARASOV, Moscow (RU); Oleg Vladimirovich TRUBNIKOV, Moscow (RU)

(21) Appl. No.: 17/119,352

(22) Filed: Dec. 11, 2020

(30) Foreign Application Priority Data
Dec. 30, 2019 (RU) 2019144994

(51) Int. Cl. H02J 50/12; H05B 45/30

(52) U.S. Cl. CPC H02J 50/12; H05B 45/30

(57) ABSTRACT

An electric power system is provided. The system is powered by power source that is connected to a frequency converter. The converter is connected via a circuit to a distributive switch that has an input and an output and to an element that is configured to store electric energy. The output is connected to a first electric wire at its first end. The second end of the first wire is connected to a first reflective element. A first device is connected to the first electric wire between the first and the second ends. A second electric wire is connected to the output at one end and the other end is connected to a second reflective element. The frequency converter is configured to transform a current generated by the power source into an increased frequency AC current for powering the first device. A method of operating the system is also provided.

### CROSS-REFERENCE TO RELATED APPLICATIONS

The present application claims priority from Russian patent application No. RU2019144994, filed on Dec. 30, 2019, incorporated by reference herein.

### FIELD OF THE TECHNOLOGY

The present technology relates to of electrical technology, particularly, to electric power systems and methods that can power devices connected to one-wire electric lines forming open circuits.

### BACKGROUND

It is known that it possible to transfer power through one wire to power various electric devices, such as light sources and motors. Work of physicists like Stephen Grey, Nikola Tesla, Stanislav Avramenko, Konstantin Avramenko and others describe various experiments related to transferring power through one wire, however, there's a lack of scalable cost-efficient engineering solutions for mass market.

A description of transmission of electrical energy along a single conducting wire that does not form a closed circuit is based on several discoveries including that by the English physicist Stephen Grey of the phenomenon of electrical conductivity in 1729. This phenomenon consists of electricity being transmitted from one body to another along a metal conductor, such that the electrical charge is distributed over the surface of the conductor (see Yu. A. Khramov, Physicists: A Biographical Reference Book (Moscow, “Nauka” 1983); and Dictionary of scientific biography (New York, Charles Scribener's Sons 1970-1978)).

It is believed that Nicola Tesla has described a means of supplying power to electrical devices via a single-wire transmission line in the late nineteenth century (see John O'Neill, Electrical Prometheus, (Moscow “History of Technology” 1944); B. N. Rzhonsnitsky, Nikola Tesla (Moscow “Molodaya Gvardiya” 1959); and G. K. Tsverava, Nikola Tesla (Leningrad “Nauka” 1974)).

In the U.S. Pat. No. 6,104,107, Stanislav Avramenko, Konstantin Avramenko have described a method of supplying electric power to an electrical device via a one wire transmission line that does not form a closed circuit. The method is characterized by the transformation of electrical energy into the energy of oscillation of a field of free electrical charges, such as the displacement current or longitudinal waves of an electrical field, and where necessary, including a transformation into the electromagnetic energy of conduction currents.

A Russian patent number RU2241176 teaches an electric lighting system that includes a solar battery, an electric energy accumulator, a charge controller, an inverter, a resonant transformer, an electric line and a set of LEDs. A high voltage terminal of a high voltage winding of the resonant transformer is connected to a single wire. Each LED of the set of the LEDs is connected in parallel to the single wire such that one LED terminal is connected to the single wire and the other LED terminal is connected to an insulated conductive body. A disadvantage of this lighting system is the presence of high electric potential (1500 volts) on the LEDs, which leads to having a risk of a short circuiting to the ground of the elements of the single wire. Also, this lighting system may be costly to set up and operate due to the safety requirement of providing an increased electrical insulation for the single wire.

A Russian patent No. RU2662796 teaches a lighting system that includes an electric energy source, a frequency converter, a resonant high-frequency transformer, an electric single wire, electric lamps, where a low-potential terminal of a Tesla transformer winding is connected to the beginning of the electric single wire. The disadvantages of this method arise from using the Tesla resonant transformers and are related to problems arising from providing power with capacities exceeding 2 kW. Also, Tesla resonant transfer itself is relatively bulky and has relatively large dimensions. Moreover, when the Tesla transformer starts operating in a resonant mode, significant voltage potentials may appear at high voltage potential output, reaching values of 1.5-14 kV. This high-potential output of the Tesla transformer may require that additional safety measures are installed in the area where the Tesla transformer is operating.

The objective of the present technology is to reduce the risk of having of high-potential components within the power system, reduce the risk of short circuiting the power system, making the power system safer than conventional electric power systems, and providing a cost-effective electric power system that has scalable technology sufficient for the needs of the mass market.

### SUMMARY

It is an object of the present technology to ameliorate at least some of the inconveniences present in the prior art.

Embodiments of the present technology have been developed based on engineers' appreciation of at least one technical problem associated with the prior art approaches to transmitting electric power in a safe and cost-efficient manner.

More specifically, the presently known prior art systems do not appear to take into account the possibility of harnessing unconventional types of electric power generated within systems operating at resonant or close to resonant modes. As such the present technology allows to design stable electrical power systems that upon entering a mode close to resonant mode, or resonant mode itself, will effectively transmit electric currents and electromagnetic waves via an electric wire in various forms including, but not limited by longitudinal currents, standing electromagnetic waves, travelling electromagnetic waves, displacement currents, recharge currents, or electromagnetic vertices, and harness those electric currents and electromagnetic waves to power various devices.

The engineers discovered that it would be beneficial to provide an apparatus or a system that will remain stable while operating at least a portion of the system in resonant mode, such that the system will be able to provide electric power to any types of devices connected in series or in parallel to an electric wire that is transmits an AC current back and forth along the wire from one end to another, thus allowing the power of the AC current present in the electric wire to be harnessed by the devices conductively connected thereto.

According to a first broad aspect of the present technology, there is provided an electric power system that has at least the following components: a power source that is conductively connected to a frequency converter, which is in turn conductively connected to via a circuit to a distributive switch that has an input and an output. The circuit has an element connected thereto, the element is configured to store electric energy. This element may be composed of several electrical components or may be a single electrical component. The distributive switch is connected to a first electric wire that has a first device conductively connected thereto. The first electric wire has a first end and a second end. The first end is connected to the output of the distributive switch. The first device is conductively connected to the first electric wire between the first and the second ends. The first device may be powered by the system. The system may be powered by any power source, for example DC or AC. The frequency converter is configured to transform the electric current generated by the power source into an increased frequency AC current. The circuit and the element may be a resonant circuit. The increased frequency AC current that is transmitted via the distributive switch into the first electric wire for powering first device, which may be a single device or a plurality of devices. There may also be a second electric wire that is conductively connected to the output of the distributive switch. The second electric wire has a third end and a fourth end. The third end may be conductively connected to the output. There may be one or more distributive switches. The distributive switch has an input that is conductively connected to the circuit. The first electric wire, is stretched away from the power source, the distributive switch and the resonant circuit, such that only the first end of the first electric wire is connected to the distributive switch and such that the second end of the first electric wire is not connected to the power source, the frequency converter, the element, the circuit or the distributive switch, i.e. does not form a closed circuit with the power source, the frequency converter, the element, the circuit or the distributive switch. The second end of the first electric wire has a first reflective element conductively connected thereto, such that the increased frequency AC current transmitted via the first electric wire is reflected from the reflective element of the second end back into the first electric wire. The fourth end of the second electric wire has a second reflective element connected thereto. The second electric wire also does not for a closed circuit with the power source, the frequency converter, the element, the circuit or the distributive switch.

In some implementations of the electric power system, there may be more electric wires that do not form a closed circuit, and that are used to transmit an increased frequency AC current in order to power other devices conductively connected to those wires. Consequently, for ease of understanding the present technology, the electric wires may be denoted as first, second, third, fourth, fifth and so on; the devices may be denoted as first, second, third, fourth, fifth and so on; the wire ends may be denoted as first, second, third, fourth, fifth and so on; such denoting is not intended to be limiting, does not change the functionality of each of these elements and does not imply any order, type, chronology, hierarchy or ranking of these nouns, and simply indicates that these nouns have a different adjective associated therewith, as is described in more detail below. It is understood that a wire can have a plurality of second ends and a plurality of first ends. The present technology teaches that for the system to function correctly the electric wire that transmits the increased frequency AC current to the device or the devices, that are conductively connected to the electric wire, does so by using the oscillating nature of the electric current, i.e. the oscillations of the electric current present between the first end(s) of the electric wire and the corresponding second end(s) of the electric wire, rather than the running-in-a-loop-in-a-closed-circuit nature of the electric current.

In some implementations of the electric power system, the first reflective element may be any of the following: an unconnected wire-end of the at least first electric wire, a capacitor, an object comprising a conductive material, a ground, and an insulation of the second end. The second reflective element may be any of the following: any of an unconnected wire-end of the at least first electric wire, a capacitor, an object comprising a conductive material, a ground, and an insulation of the fourth end. A reflective element does not have to be anything specific on the unconnected ends of any of the electric wires, as long as the unconnected ends do not hinder the ability of its respective electric wires to transmit electromagnetic waves between the ends of an electric wire.

In some implementations of the electric power system, for example, when the dimensions of the first electric wire are sufficient to provide an intrinsic capacitance of the first electric wire to operate the electric power system in a close to a resonant mode or in resonant mode, the reflective element may be the second end of electric wire itself, which is unconnected. For example, the second end may be insulated and that will be sufficient for the system to operate. Similarly, when the dimensions of the second, third, fourth, etc. electric wires are sufficient to provide an intrinsic capacitance of any of these electric wires to operate the electric power system close to resonant mode or in resonant mode, the reflective elements may be the unconnected ends of the electric wires themselves.

In some implementations of the electric power system, for example, when the dimensions of the first electric wire are insufficient to provide an intrinsic capacitance of the first electric wire to operate the electric power system close to a resonant mode or in resonant mode, the reflective element may an object that adds to capacitance to the first electric wire. For example, such an object may be any conductive body. The conductive body may be of any shape or form, for example: a ball, a torus, a disk, a rod, a cylinder, or an extended portion of an electric wire. In some cases, the ground may be used as the reflective element (by grounding the first electric wire) provided that a closed circuit is not formed by the second end of the first electric wire via the ground to the power source, the resonant circuit, or the distributive switch. Similarly, when the dimensions of the second, third, fourth, etc. electric wires are insufficient to provide an intrinsic capacitance of each of these electric wires to operate the electric power system close to a resonant mode or in resonant mode, the reflective element may an object that adds to capacitance to each of those electric wires.

In some implementations of the electric power system, a second device is conductively connected to the second wire between the third end and the fourth end. The second device may be a plurality of second devices.

In some implementations of the electric power system, first device or the second device may be a light source, sound source, an electromechanical powered device, an electromagnetically powered device, or any other device that uses electric power to operate.

In some implementations of the electric power system, there may be a plurality of first devices conductively connected to the first electric wire, and a plurality of second devices conductively connected to the second wire. The plurality first devices or the plurality of the second devices may be a combination of light sources, sound sources, electro-mechanical powered devices, or electromagnetically powered devices.

In some implementations of the electric power system, each of the plurality of first devices or each of the plurality of second devices may have an equivalent power consumption between each other, or may be of a similar type.

In some implementations of the electric power system, the each of the plurality of first devices may be spaced from each other having an either relatively equal distance from one first device to another, or having a distance from one first device to another as a function of resonance of the electric power system or the needs of a user of the electric power system.

In some implementations of the electric power system, the plurality of first devices or the plurality of second devices may be one of a plurality of light emitting diodes, a plurality of gas lamps, or a plurality of incandescent lamps, a plurality of compact fluorescent lamps, a plurality of halogen lamps, a plurality of metal halide lamps, a plurality of fluorescent tubes, a plurality of neon lamps, a plurality of high intensity discharge lamps, or a plurality of low pressure sodium lamps.

In some implementations of the electric power system, in the plurality of light emitting diodes at least two light emitting diodes may connected to the first electric wire in opposite directions. The increased frequency AC current transmitted from the first end of the first electric wire towards the second end of the electric wire may power the light emitted diodes that are connected in the direction from the first end of the first electric wire towards the second end of the first electric wire. The increased frequency AC current that is reflected from the second end of the electric wire and transmitted from the second end of the first electric wire towards the first end of the electric wire may power the light emitted diodes that are connected in the direction from the second end of the first electric wire towards the first end of the first electric wire. Similarly, the light emitting diodes conductively connected to second, third, fourth, etc. electric wires may be powered by the increased frequency AC currency, as described above for the first electric wire.

In some implementations of the electric power system, a first set of the plurality of first devices is conductively connected in a sequence to the at least one first electric wire.

In some implementations of the electric power system, a second set of the plurality of first devices is conductively connected in parallel to the first electric wire. Consequently, the first electric wire may have a plurality of second ends.

For example, when at least some of the first devices are connected in parallel, the second end of the first electric wire may have a plurality of second ends, such that the first devices connected in parallel will have one terminal conductively connected to the first electric wire on the side of the first end and the second terminal connected on the side of the second end, ensuring that no closed circuits are formed by the first electric wire.

In some implementations of the electric power system, a third set of the plurality of first devices includes two light emitting diodes conductively connected to the first electric wire in antiparallel.

In some implementations of the electric power system, it is possible to conductively connect any of the first devices either in sequence or in parallel while keeping the system operational in resonant mode or close to resonant mode.

In some implementations of the electric power system, the circuit includes a capacitor and an inductor. For example, the element may consist of a single capacitor or a set of capacitors. Also, it is possible that the element may consist of a capacitor and an inductor connected in series creating a resonant contour. There may numerous combinations possible for ensuring that the circuit and the element have a function of storing at least a portion of the electric energy of the system, as such, it is understood that the number of capacitors, inductors, windings, resistance objects, circuits is not limited in any way, and the present technology does not limit the manner in which the capacitors, inductors, windings, resistance objects, circuits may be interconnected, whether it is in series or in parallel or in a combination of both, as long as the circuit and the element are capable of storing at least a portion of the electric energy of the system.

In some implementations of the electric power system, the first device may be powered, when the system is operating close to a resonant mode or when the system is operating in resonant mode.

In some implementations of the electric power system, the circuit and the element generate at least 70% of resonance effects of the system, when the system is operating close to a resonant mode or when the system is operating in resonant mode.

In some implementations of the electric power system, the increased frequency AC current transmits into the conductively connected, to the output of the distributive switch, electric wires a combination of any of a longitudinal current, a standing electromagnetic wave, a travelling electromagnetic wave, a displacement current, a recharge current, or electromagnetic vertices.

In some implementations of the electric power system, the increased frequency AC current is in a range between 1 kilohertz and 1 megahertz.

In some implementations of the electric power system, distributive switch may be a transformer.

In some implementations of the electric power system, transformer may be an impedance-matching transformer. The transformer may have n (n=2, 3, 4, 5) windings identical or close in parameters. The input winding of the transformer is connected to the circuit. Each of the n−1 transformer output windings may be connected to the first and to the second electrical wires that transmit the increased frequency AC current to the first and second devices. The transformer may be a step-down transfer. The transformation ratio of the transformer may be in a range of 0.2 to 5.

According to another broad aspect of the present technology, there is provided a method of operating an electric power system. The method may have the following steps. For example, the steps may be the following.
a. Receiving a current from a power source and converting the current into an increased frequency AC current by a frequency converter, such that the increased frequency AC current is in a range of 1 kilohertz to 1 megahertz.
b. Storing a first portion of an electric energy of the system in a circuit conductively connected to an element.
c. Transmitting the increased frequency AC current from the circuit to a first end of a first electric wire, and to a third end of a second electric wire.
d. Reflecting a first portion of the increased frequency AC current from a second end of the first electric wire.
e. Reflecting a second portion of the increased frequency AC current from a fourth end of the second electric wire.
f. Operating the system close to a resonant mode.
g. Powering by the increased frequency AC current a first device, the first device being conductively connected to the first wire between the first end and the second end.

These steps may in arranged in an order suitable for properly operating the present technology.

In some implementations of the method, the step of converting the current into the increased frequency AC current, includes the step of determining a resonant frequency of the system, and the step of converting the current generated by the power source into a resonant frequency AC current, the resonant frequency AC current being within 40% of the resonant frequency of the system. The element of the circuit may consist of an inductor and a capacitor conductively connected in series, or in any other combination of inductors and capacitors, and other elements connected either in parallel or in series suitable for the present technology. The circuit and the element are configured to store electrical energy of the system. In examples, when it's required to create an electric power system of sufficiently high power, the circuit and the element may be able to accumulate significant energy therein. To solve the problem of accumulating significant energy in the circuit, the present technology teaches to provide a resonant contour, for example: an inductor and a capacitor of dimensions suitable for the needs of accumulating energy.

In some implementations of the method, the step of powering the first device by the increased frequency AC current includes powering the first device by a combination of any of a longitudinal current, a standing electromagnetic wave, a travelling electromagnetic wave, a displacement current, recharge current, or electromagnetic vertices. The present technology teaches that when an AC current travels back and forth, i.e. oscillates, in an electric wire that does not form a closed circuit, the electric effects caused by this oscillation produce important power that can be transferred to power devices conductively connected to that electric wire.

In some implementations of the method, the step of powering the first device by the increased frequency AC current and the step of powering another device by at least the reflected portion of the increased frequency AC current includes powering a plurality of light sources, sound sources, electro-mechanical powered devices, or electromagnetically powered devices.

In some implementations of the method, the step of powering the plurality of light sources, includes powering a plurality of light emitting diodes connected to the first electric wire in antiparallel.

In some implementations of the method, further comprises the steps of transmitting the increased frequency AC current from the resonant circuit to a third end of a second electric wire, the step of powering a second device by the increased frequency AC current transmitted via the second electric wire, the step of reflecting at least a portion of the increased frequency AC current from the fourth end of the second electric wire, and the step of powering an additional device by at least the portion of the increased frequency AC current. When the increased frequency AC current travels back and forth, i.e. oscillates, in an electric wire that has devices conductively connected thereto, such that these devices consume the power generated by the increased frequency AC current, there may be effects present in this electric wire where the longitudinal currents, standing electromagnetic waves, travelling electromagnetic waves, displacement currents, recharge current, or electromagnetic vertices.

In some implementations of the method, the method further comprises the steps of correcting the increased frequency AC current based on receiving data from any of the element, the circuit, frequency converter, the first electric wire, the first device, and sensors connected to the system.

In some implementations of the method, the method further comprises the step of setting up the system close to the resonant mode by determining the resonant frequencies of any of the system and the circuit.

In some implementations of the present technology, the circuit and the element may be a resonant contour.

In the context of the present specification, unless specifically provided otherwise, an “electric wire” or a “single-wire electric wire” is any type of wire that conducts electricity. It may be one electric wire or multiple electric wires, both of which are included within the expressions “first electric wire”, “electric wire”, or “second electric wire”, as long as those wires are not connected in a closed-loop circuit.

In the context of the present specification, unless specifically provided otherwise, a “device” is any device capable being powered by electricity, and may be one electric wire or multiple electric wires, both of which are included within the expressions “first device”, “at least one device”, or “second device”.

In the context of the present specification, unless specifically provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first electric wire” and “second electric wire” is not intended to imply any particular order, type, chronology, hierarchy or ranking (for example) of/between the electric wires, nor is their use (by itself) intended to imply that any “second electric wire” must necessarily exist in any given situation. Further, as is discussed herein in other contexts, reference to a “first” element and a “second” element does not preclude the two elements from being the same actual real-world element. Thus, for example, in some instances, a “first” electric wire and a “second” electric wire may be the same wire in some cases, and a “first” electric wire and a “second” device may be the same device in some cases, in other cases they may be different wires and different devices.

The terms “conductively connected” and “connected” are used interchangeably and mean that there is a such a connection between electric components (including wires) that electric energy may pass between them. It does not have to be a physical connection, as an electro-magnetic connection is sufficient for the transfer of electric energy between electric components (including wires). The term “circuit” means that there is a loop through which conventional electric energy flows. The term circuit is opposite to the concept of an “non-closed-loop”, or “open circuit”, or “single-wire”. The term “single-wire” refers to an electric wire that is used transmission of electric energy via electro-magnetic oscillations as opposed to a conventional circuit, i.e. closed circuit, transmission of electric energy.

no electro-magnetic transfer of electric energy between certain specified components and, typically, may refer to the concept that a non-closed loop.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram of a system implemented in accordance with an embodiment of the present technology.

FIG. 2 is a schematic diagram of a system implemented in accordance with an embodiment of the present technology.

FIG. 3 is a schematic diagram of a system implemented in accordance with an embodiment of the present technology.

FIG. 4 is a schematic diagram of a system implemented in accordance with an embodiment of the present technology.

FIG. 5 is a schematic diagram of a system implemented in accordance with an embodiment of the present technology.

FIG. 6 is a schematic diagram of a system implemented in accordance with an embodiment of the present technology.

FIG. 7 is a schematic diagram of a system implemented in accordance with an embodiment of the present technology.

FIG. 8 is a schematic diagram of a system implemented in accordance with an embodiment of the present technology.

FIG. 9 is a schematic diagram of a system implemented in accordance with an embodiment of the present technology.

FIG. 10 is a schematic diagram of a system implemented in accordance with an embodiment of the present technology

FIG. 11 is a schematic diagram of a system implemented in accordance with an embodiment of the present technology.

FIG. 12 is a schematic diagram of a system implemented in accordance with an embodiment of the present technology.

FIG. 13 is a schematic diagram of a system implemented in accordance with an embodiment of the present technology.

FIG. 14 is a schematic diagram of a system implemented in accordance with an embodiment of the present technology.

FIG. 15 is a schematic diagram of a system implemented in accordance with an embodiment of the present technology.

FIG. 16 is a schematic diagram of a system implemented in accordance with an embodiment of the present technology.

FIG. 17 is a schematic diagram of a system implemented in accordance with an embodiment of the present technology.

FIG. 18 is a schematic diagram of a system implemented in accordance with an embodiment of the present technology.

### DETAILED DESCRIPTION

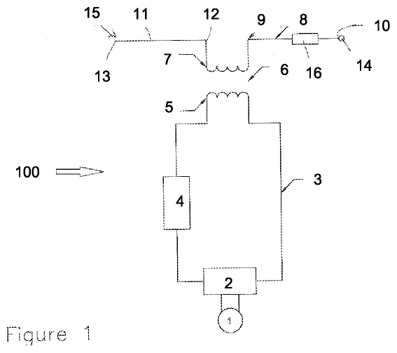

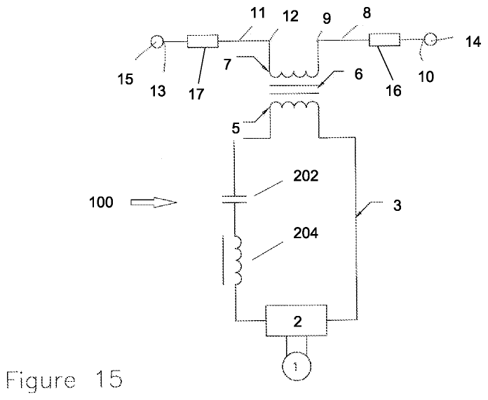

Referring to FIGS. 1 to 18, there is shown a diagram of an electric power system 100, the system 100 is suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises a power source 1. The power source 1 is may be typically associated with a DC or an AC power source (not depicted), and may be a conventional power source stemming from conventional electric lines, whether indoor, outdoor, industrial, home-systems, batteries, and the like. It should be noted that the fact that the power system 1 is associated with any type of power source does not need to suggest or imply any mode of operation other than providing electric power to the system.

The system 100 further comprises a frequency converter 2, an element 4, a distributive switch 6, all of which are conductively connected to via the circuit 3. The implementation of the circuit 3 with the electric components connected thereto is not particularly limited, but as an example, the frequency converter 2, the element 4 and the distributive switch 6 are shown to be connected in a series, whoever, they may be connected in parallel or in a combination of series and parallel. It is understood that there may be several frequency converters 2, several elements 4 and several distributive switches 6, depending on the requirements of the system 100.

The frequency converter 2 converts the electric energy, that it receives from the from the power source 1, into an increased frequency AC current. An industrial standard electric energy may be, for example, a one or three phases 50 or 60 Hertz AC current that may be generated by the power source. The increased frequency AC current may be anywhere between 1 kilohertz and 1 megahertz. The illustrative purposes only, the frequency converter 2 may convert the electric energy into a 10 to 60 kilohertz frequency AC current. For example, the frequency converter 2 may consist of an active rectifier with a power factor correction (PFC) function and an output stage that may be assembled on gallium nitride transistors capable of operating in soft and hard switching modes (not depicted). The output stage may be controlled by a microcontroller. The developed power may be up to 2 kW. The voltage swing at the output of the frequency converter may correspond to the PFC voltage and may be 400 V. Other implementations of the frequency converter 2 are possible as may be appreciated by a person skilled in the art.

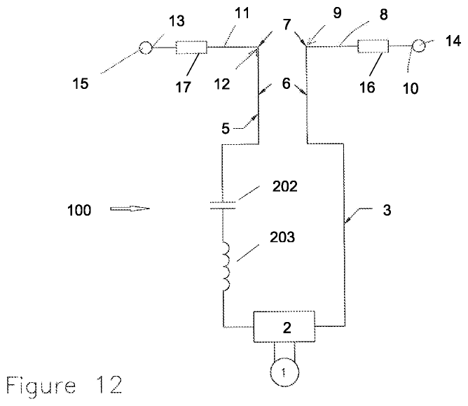

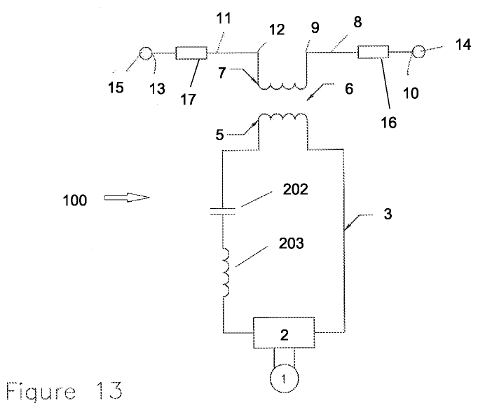

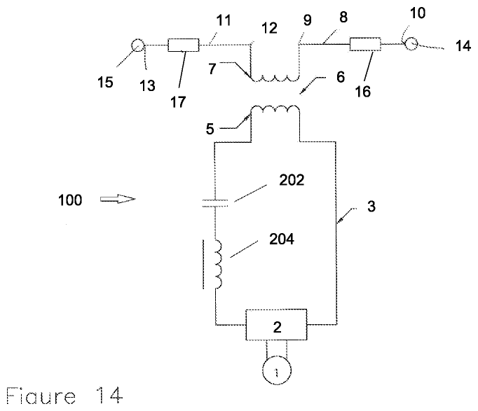

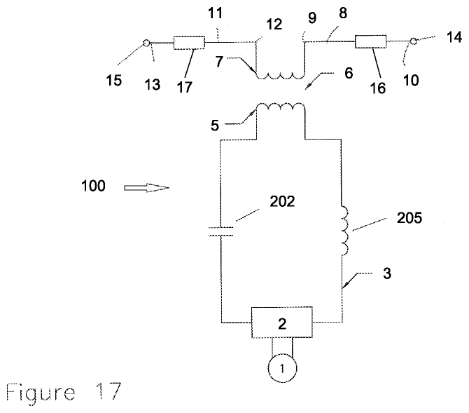

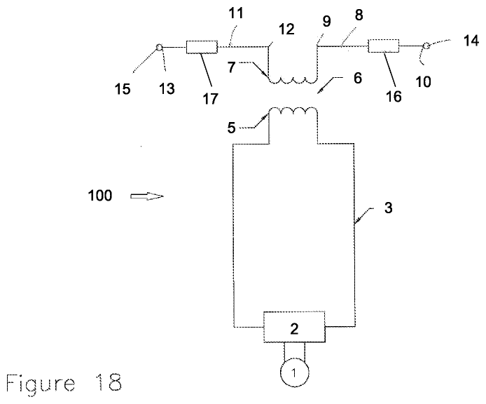

The element 4 is a shown for illustrative purposes as an independently connected component of the circuit 3. However, in some implementations of the present technology, the element 4 may be part of the frequency converter 2, as shown in FIG. 18. The element 4 may consist of an inductor 203 and a capacitor 202, as shown in FIGS. 12 and 13, or as an inductor 204 and a capacitor 202, as shown in FIGS. 14, 15 and 16, or an inductor 205 and a capacitor 202 as shown in FIG. 17. The inductor 203 may have an air core, the inductor 204 may have an iron or any other core, and the inductor 205 may be any other type of component that has an inductance. For example, in certain experiments, an inductor 204 was used, where the inductor 204 was selected from a set of inductors that consisted of a toroidal coil with a core. The cores had a height that varied between 5 and 184 mm and a diameter that varied between 10 and 170 mm. The wires that were wound around the core had diameters that varied between 0.5 and 10 mm. The number of turns varied between 10 and 200. The capacitor 202 was selected from a set of capacitors that had ratings varying between 1 and 560 nF. In several experiments, the inductors 204 had cores having the parameters: height 15-25 mm, diameter 20-25 mm, winding wire diameter 1-2 mm, and 30-50 winding turns, and the capacitors 202 had ratings that varied between 30 and 90 nF. In several experiments, there was no inductor 203, 204 or 205 used in the circuit and only a capacitor 202 was used (this arrangement may be understood from FIGS. 1-11, where the element 4 is shown as the component of the circuit 3 that functions as the component for storing at least a portion of the electric energy of the system 100. In some experiments, the element 4 was a capacitor and the distributive switch 6 had transformer winding at the input 5, such that when the system 100 was in resonant mode, the capacitor in the element 4 and the winding of the input 5 acted as a resonant contour of the circuit 3. In other experiments, the element 4 consisted of a combination of capacitors and a combination of inductors that were connected either in series, in parallel or both (not depicted), that acted as a resonant contour of the circuit 3. It is understood for a person skilled in the art that any suitable arrangement of the element 4, frequency converter 2, and the distributive switch 6 is possible, as long as the system 100 may function in resonant mode or close to resonant mode.

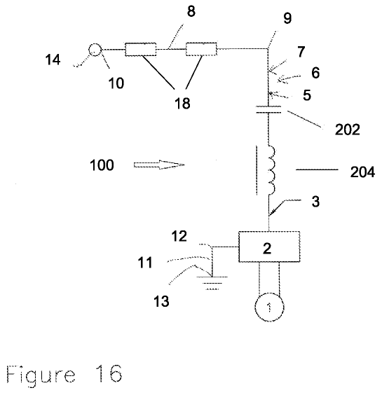

In several experiments, the distributive switch 6 was selected from a set of different types of transformers (FIGS. 1-11, 13-15, 17 and 18) or from a set of different types of wiring arrangements (FIGS. 12 and 16). For example, in some experiments the transformers were selected from the following non-limiting list of power transformers: core transformer, toroidal transformer, autotransformer, variable autotransformer, phase-shifting transformer, resonant transformer, ferrite core, planar transformer, isolating transformer, solid-state transformer. It is understood that it is possible to use any type of transformer that may act as a distributive switch 6, including, but not limited to power transformer, output transformer, pulse transformer, etc.

In several experiments, the distributive switch 6 was selected from a set of isolating transformers, in some cases that acted as impedance-matching transformers with a toroidal core, with external diameters that varied between 20 and 56 mm, and heights that varied between 10 and 350 mm (not depicted). Some of those transformers had one input and one output winding, others had several input and several output windings (not depicted). It is understood that it is possible to select any suitable dimensions and any the type of a transformer for the distributive switch 6, depending of the requiems of the system 100, based on the requiems of a specific use case. In some experiments, the isolating transformer had identical input and output windings. The windings were selected from a set of copper wires varying in diameters between 0.5 and 10 mm. The number of turns of the windings varied between 10 and 100. In experiments, where the windings were identical, the transformation coefficient of the transformer was 1. In experiments, where the windings were not identical, the transformation coefficient of the transformer varied depending on the requirements of the system 100 in each particular use case.

The circuit 3 with the components connected thereto, particularly, the frequency converter 2, the element 4 and output 5 of the distributive switch 6 are all connected in a circuit and at least one of these components acts as a resonant circuit. In some literature, the resonant contour is described as “resonant LCR circuits”, “resonance in AC circuits”, “resonant contour”, “LC circuit”, “resonant circuit” or the like. It is understood that in this specification the meaning of the term “resonant contour” is not limited to any particular arrangement of electric components, rather it is associated with the possibility of the system 100 to enter resonant mode, such that the circuit 3 and the electric components connected thereto will store a significant enough portion of the electric energy of the system 100 to keep the system 100 stable when it is in operation.

In the context of the present technology, the resonant frequency of the resonant contour may be calculated as:

$${f}_{circuit} = \frac{1}{2 π \sqrt{LC}} ,$$

where L is the total loop inductance (Lᵢ and L_{T}), where Lᵢ—is the inductance of the inductor and L_{T} is the inductance of the transformer, C is the capacitance of the capacitor. The resonant contour of the circuit 3 acts as an intermediary electric energy storage that is used to determine the resonant frequency of the system 100, in order to operate the system 100 in resonant mode. In some implementations of the present technology, it is possible to operate the system 100 close to the resonant frequency of the resonant contour of the circuit 3.

The system 100 further comprises a first electric wire 8 and a second electric wire 11. The electric wires 8 and 11 are single-wire electric wires that have their respective first end 9 and third end 12 connected to the output 7 of the distributive switch 6. The distributive switch 6 is represented as a transformer and is depicted as having an input winding at its input 5 and an output winding at its output 7. The first end 9 and the third end 12 are connected to output windings of the output 7 of the distributive switch 6. The first wire 8 has a second end 10, which is does not form a closed-loop circuit, i.e. it remains unconnected from the circuit 3 and any of its components. The second end 10 is connected to a first reflective element 14. The second wire 11 has a fourth end 13, which is does not form a closed-loop circuit, i.e. it remains unconnected from the circuit 3 and any of its components. The fourth end 13 is connected to a second reflective element 15.

The first and second reflective elements 14 and 15 respectively may be any of the following: an unconnected wire-end itself, a capacitor, an object comprising a conductive material, a ground, or an insulation of the ends of the first or second wires 8 and 11 respectively. As shown in FIG. 16, the fourth end 13 of the second wire 11 is connected to the second reflective element 15, which is the ground. Notably, the ground does not provide a measurable transmission of electric energy to the circuit 3 or any of its components.

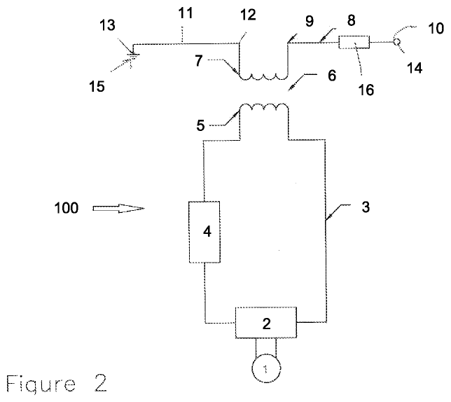

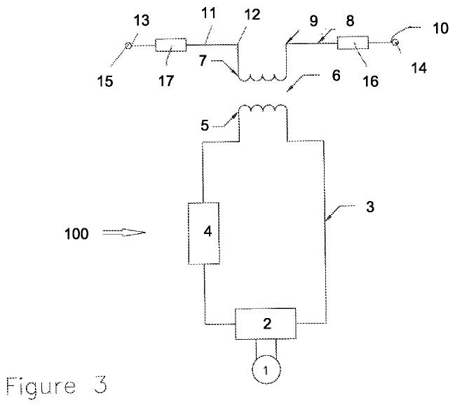

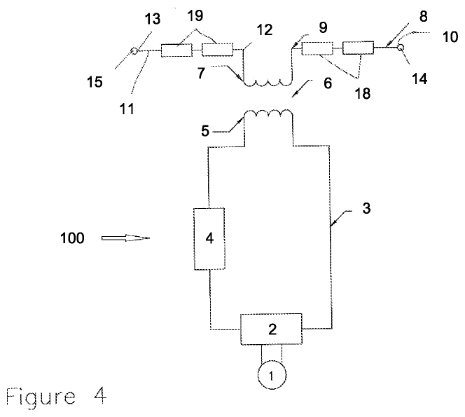

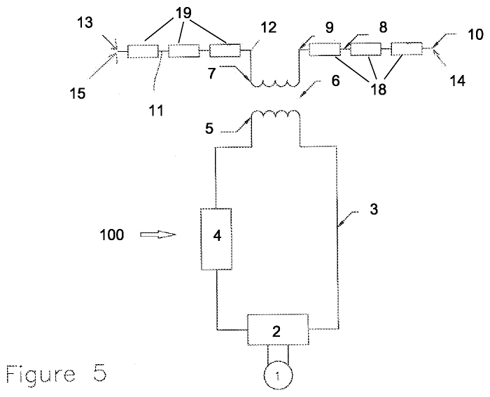

In some embodiments, the first and second reflective elements 14 and 15 may be similar, however, it is not required. For example, FIG. 1 shows that the first wire 8 has a first reflective element 14, which is shown as a spherical body and the second wire 11 is shown to have a second reflective element 15 as the end 13 of the second wire 11. For example, FIG. 2 shows that the first wire 8 has a first reflective element 14, which is shown as a spherical body and the second wire 11 is shown to have a second reflective element 15 as ground to which the second wire 11 is grounded. For example, FIGS. 3 and 4 shows that the first wire 8 has a first reflective element 14, which is shown as a spherical body and the second wire 11 is shown to have a second reflective element 15 as a spherical body. For example, FIG. 5 shows that the first wire 8 has a first reflective element 14, which is shown as the end 10 of the first wire 8 and the second wire 11 is shown to have a second reflective element 15 as the end 13 of the second wire 11. The arrangement show in FIG. 5 may be used, for example, when the first and the second wires 8 and 11 have sufficient intrinsic capacitances for the system 100 to stably operate in resonant mode. In some experiments, the arrangement of FIG. 5 was used with first and second wires 8 and 11 having a length of over 500 meters, the first and second wires 8 and 11 being stretched in opposite directions.

FIGS. 1-5 show that the system 100 may have a first device 16 connected to the first wire 8 (FIG. 1) and the second device 17 connected to the second wire 11 (FIG. 3). It is possible that the first device 16 is a plurality of first devices 18, which are connected to the first wire 8 (FIG. 4). It is possible that the second device 17 is a plurality of second devices 19, which are connected to the second wire 11. The devices in the plurality of first devices 18 and in the plurality of second devices 19 are not required to be similar or identical. The number of devices in the plurality of first devices 18 and in the plurality of second devices 19 do not have to be the same, for example, there may be one number of devices in the plurality of first devices 18 and there may be another number of devices in the plurality of second devices 19. In FIGS. 1-5 the devices are connected in series to the first and to the second wires 8 and 11 respectively.

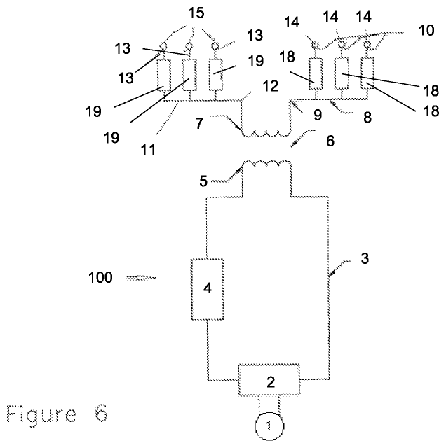

FIG. 6 shows a connection in parallel of the plurality of first devices 18 to the first wire 8 and of a plurality of second devices 19 to the second wire 11. A plurality of second ends 10 of the first wire 8 and a plurality of first reflective elements 14 connected to each of the ends of the plurality of second ends 10 is also shown. A plurality of fourth ends 13 of the second wire 11 and a plurality of second reflective elements 15 connected to each of the ends of the plurality of fourth ends 13 is also shown.

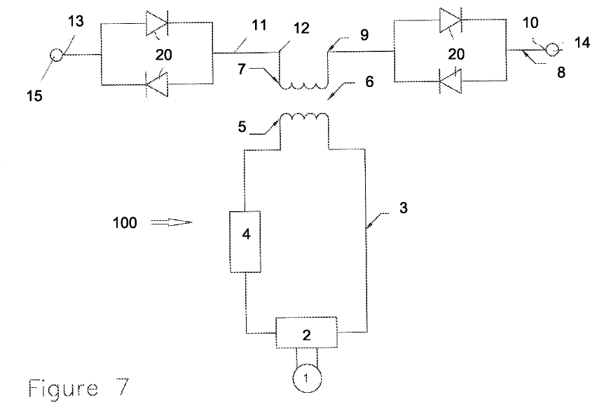

FIG. 7 shows a LEDs 20 connected in antiparallel to the first wire 8 and connected in antiparallel to the second wire 11. In this embodiment of the technology, a portion of the LEDs 20 connected to the first wire 8 are powered by the increased frequency AC current travelling from the first end 9 to the second end 10, and another portion of the LEDs 20 connected to the first wire 8 are powered by the increased frequency AC current that is being reflected from the first reflective element 14 and that is travelling from the second end 10 to the first end 9 of the first wire 8. Similarly, a portion of the LEDs 20 connected to the second wire 11 are powered by the increased frequency AC current travelling from the third end 12 to the forth end 13, and another portion of the LEDs 20 connected to the second wire 11 are powered by the increased frequency AC current that is being reflected from the second reflective element 15 and that is travelling from the fourth end 13 to the third end 12 of the second wire 11.

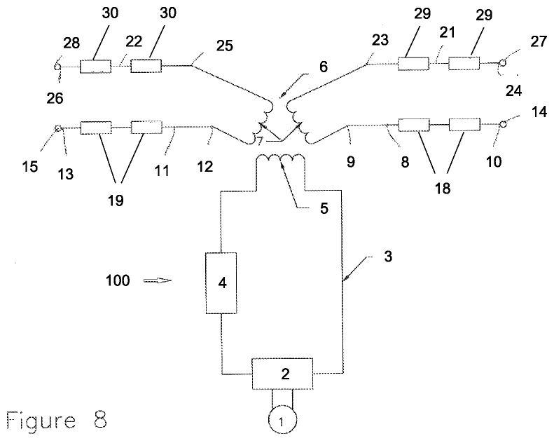

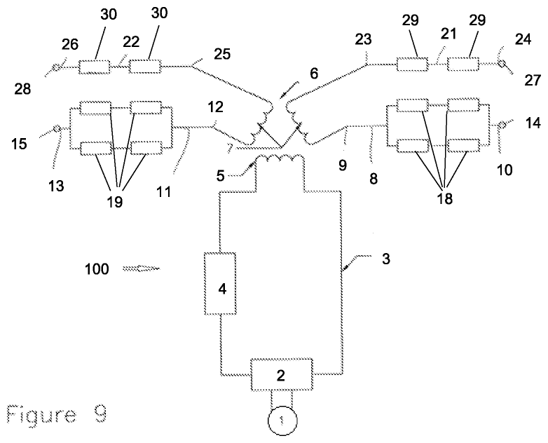

FIG. 8 shows an embodiment of the technology having a first wire 8, a second wire 11, a third wire 21 and a fourth wire 22 connected to the output 7 of the distributive switch 6 via their respective ends: first end 9, third end 12, fifth end 23 and seventh end 25. The third wire 21 has a sixth end 24 to which a third reflective element 27 is connected, and a third device consisting of a plurality of third devices 29 connected to the third wire 21 between the fifth end 23 and the sixth end 27. The fourth wire 22 has an eighth end 26 to which a fourth reflective element 28 is connected, and a fourth device consisting of a plurality of fourth devices 30 connected to the fourth wire 22 between the seventh end 25 and the eighth end 26. The distributive switch 6 is shown to have two outputs 7 to which the first, second, third and fourth wires 9, 11, 21 and 22 are connected. The increased frequency AC current is transferred to the first, second, third and fourth wires 9, 11, 21 and 22 respectively, to power the plurality of the first, second, third and fourth devices 18, 19, 29 and 30 respectively. The distributive switch 6 is shown to be a transformer with an input winding at its input 5 and two output windings at its two outputs 7. The system 100 operates in or close to resonant mode where the resonant mode is determined by all the components of the system 100, including the circuit 3 and the electric components connected thereto, and the first, second, third and fourth wires 8, 11, 21 and 22 respectively and the electric components connected thereto. In the embodiment shown in FIG. 8, the plurality of first devices 18 is connected in series to the first wire 8, the plurality of second devices 19 is connected in series to the second wire 11, the plurality of third devices 29 is connected in series to the third wire 21, and the plurality of fourth devices 30 is connected in series to the fourth wire 22. It is understood, that the devices may be connected in parallel, antiparallel, on in a combination of series, parallel, antiparallel, or any other suitable arrangement that depends on the requirements of the system 100. For example, the embodiment in FIG. 9, shows that the plurality of first devices 18 is connected in a combination of series and parallel (or antiparallel) to the first wire 8, the plurality of second devices 19 is connected in a combination of series and parallel (or antiparallel) to the second wire 11, the plurality of third devices 29 is connected in series to the third wire 21, and the plurality of fourth devices 30 is connected in series to the fourth wire 22.

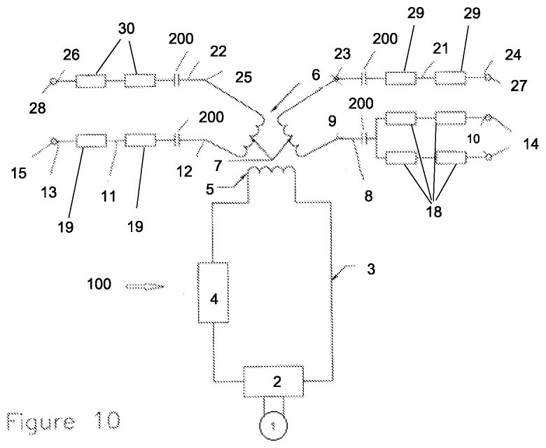

FIG. 10 shown an embodiment of the present technology, where the first wire 8 has a capacitor 200 connected thereto between the first end 9 and the second end 10, the second wire 11 has a capacitor 200 connected thereto between the third end 12 and the fourth end 13, the third wire 21 has a capacitor 200 connected thereto between the fifth end 23 and the sixth end 24, and the fourth wire 22 has a capacitor 200 connected thereto between the seventh end 25 and the eighth end 26. In some embodiments, the capacitor 200 may add capacitance to the wire it is connected to, such that the reflective element may not be required to operate the system 100 in or close to resonant mode (not depicted). In some embodiments, the capacitor 200 may function to create a resonant contour connected to the single-wire electric wires instead or in addition to the resonant contour connected to the circuit 3 (not depicted). In some embodiments, the capacitor 200 may add stability to the system 100, when the system 100 is operating in or close to resonant mode.

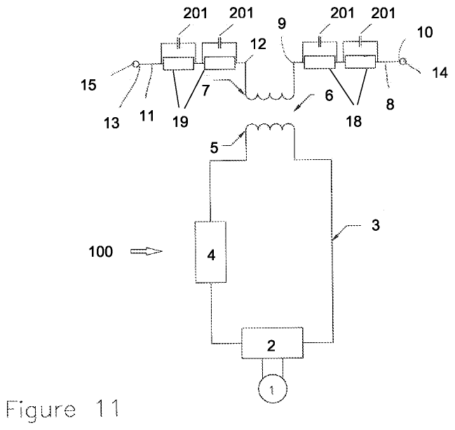

FIG. 11 shows an embodiment of the system 100, where the first wire 8 has a plurality of capacitors 201 connected thereto, such that each capacitor 201 and each device of the plurality of first devices 18 are connected in parallel to the first wire 8, and the second wire 11 has a plurality of capacitors 201 connected thereto, such that each capacitor 201 and each device of the plurality of second devices 19 are connected in parallel to the second wire 11. It is understood that the capacitors 201 and the devices 18 or 19 may be connected to the single-wire electric wires 8 or 11 in parallel, in series or in combination of series or parallel or otherwise. In some embodiments, the capacitor 201 may add capacitance to the wire it is connected to, such that the reflective element may not be required to operate the system 100 in or close to resonant mode (not depicted). In some embodiments, the capacitor 201 may function to create a resonant contour connected to the single-wire electric wires instead or in addition to the resonant contour connected to the circuit 3 (not depicted). In some embodiments, the capacitor 201 may add stability to the system 100, when the system 100 is operating in or close to resonant mode.

FIG. 12 shows an embodiment of the system 100, where the distributive switch 6 consists of at least two wires connected to the frequency converter 2 from opposite terminals. What is shows as the circuit 3 in other embodiments where the distributive switch 6 is a transformer, is no longer a circuit, i.e. does not form a closed loop in a conventional meaning. FIG. 12 shows the system 100 as a resonant contour connected to the first wire 8 and to the second wire 11 on opposite sides of the frequency converter 2, such that the first end 9 of the first wire 8 is connected to the output 7 of a wire connected to the frequency converter 2 on one terminal and the third end 12 of the second wire 11 is connected to the output 7 of a wire connected to the frequency converter 2 on the other terminal. A resonant contour consisting of a capacitor 202 and an inductor 203 is connected to the wire that is further connected to the third end 13 of the second wire 11. It is understood that the resonant contour may be connected to the wire that is further connected to the first end 9 of the first wire 8. It is understood that the distributive switch 6 may be any suitable configuration of wires or electric components as long as the first and the second wires 8 and 11 do not form a circuit, i.e. a closed loop, and provide the possibility of operating the system 100 in a resonant mode or close to resonant mode.

FIG. 13 shows an embodiment of the system 100, where the circuit 3 has a capacitor 202 and an inductor 203 connected thereto forming a resonant contour. It is understood that the resonant contour may be created within the system 100 in any manner that may be required by the needs of the system 100.

FIG. 16 shows an embodiment of the system 100, where the distributive switch 6 is the wiring that connects the first wire 8 to the wire that is connected to one terminal of the frequency converter 2 and the second wire 11 to the wire that is connected to another terminal of the frequency converter 2. The second reflective element 14 that is connected to the fourth end 13 of the second wire 11 is the ground. The ground acts enough capacitance to the second wire 11 to keep the system 100 operating stably when it operates in or close to resonant mode.

FIG. 17 shows an embodiment of the system 100, where the capacitor 202 is connected to the circuit 3 of the side of one terminal of the frequency converter 2 and the inductor 205 is connected to the circuit 3 on the side of the other terminal of the frequency converter 2.

FIG. 18 shows an embodiment of the system 100, where the electric components used to store the electric energy of the system 100 are within the frequency generator 2 box, such that when the system 100 is in resonance, at least some of the components within the frequency generator 2 box act as a resonant contour. These components may include at least a capacitor and an inductor.

In an embodiment of the system 100 may that consists of a power source 1, a frequency converter 2, a distributive switch 6, which is a transformer, an element 4, and m (where m=2, 4, 6, 8, etc.) single-wire electric wires, and k (where k=2, 4, 6, etc.) devices connected to the m single-wire electric wires. The devices may be a plurality of light sources. The transformer may have n (where n=2, 3, 4, 5) windings. The windings may be identical or may have similar technical characteristics. The input winding of the transformer may be connected in series via a circuit to a frequency converter and a resonant contour. Each of the n−1 transformer output windings is connected to a pair of single-wire electric wires, for example, to the first and second electric wires 8 and 11 respectively. The single-wire electric wires, first and second wires 8 and 11, are stretched away from the transformer output winding, the output 7, such that no electric energy passes from the first wire 8 to the second wire 11 and vis-versa.

When the system 100 is in operation, the power source 1 send a current to the frequency generator 2. The current may typically be an AC current from a conventional electricity outlet. The frequency convert 2 converts that current into an increased frequency AC current that is in the range of 1 kilohertz and 1 megahertz. The element 4 of the circuit 3 acts as a resonant contour, i.e. if the element 4 is composed of an at least one a capacitor and an inductor, and stores at least a portion of the electric energy of the system 100. The increased frequency AC current is then transmitted to the first end 9 of the first wire 8 and to the third end 12 of the second wire 11, which then travels via the first and the second wires 8 and 11 towards the second and the fourth ends 10 and 13 respectively. When the increased frequency AC current reaches the second and the fourth ends 10 and 13, it is reflected into the first and the second wires 8 and 11 respectively and travels back to the first end 9 and to the second end 12. When at least one first device 16 is connected to the first wire 8 between the first and second ends 9 and 10, the increased frequency AC current produces work, i.e. electricity is transmitted to the first device 16, thus powering the first device 16. When at least one second device 17 is connected to the second wire 1 between the third and the fourth ends 12 and 13, the increased frequency AC current produces work, i.e. electricity is transmitted to the second device 17, thus powering the second device 17. As the first and the second wires 8 and 11, and the first and second reflective elements 14 and 15 have a capacitance, the system 100 enters a resonant mode once the resonant frequency of the system 100 is reached, i.e. the increased frequency AC current is close to or at the resonant frequency of the system 100. While the system 100 is not yet in resonant mode, the frequency converter 2 may apply several different AC frequencies to determine the frequency closest to resonant frequency of the system 100. There may also be a number of sensors connected different components of the system 100 (not depicted) that may send data to a microprocessor (not depicted) that may be connected to the frequency converter 2 or to any other suitable component of the system 100. This data may be used to help determine the resonant frequency of the system 100. In cases, when there may be several resonant frequencies of the system 100, the microprocessor or the frequency converter 2 will select the most suitable resonant frequency for the increased frequency AC current. Typically, the frequency converter 2 will convert the current from the power source 1 into an increased frequency AC current that is within 40% of the resonant frequency of the system. For example, if the resonant frequency of the system 100 is f, then the increased frequency AC current may be anywhere from −40% to +40% of f.

It is contemplated that the devices connected to the single-wire electric wires, for example, the first and the second devices 16 and 17 may be powered at least in part by a combination of any of a longitudinal current, a standing electromagnetic wave, a travelling electromagnetic wave, a displacement current, recharge current, or electromagnetic vertices. The present technology does not preclude that the first and the second devices 16 and 17 may be powered directly by the increased frequency AC current. In fact, the present technology is not limited to any explanation of the electro-magnetic phenomena that may be taking place within the single-wire electric wires, for example, the first and the second wires 8 and 11 respectively.

In some cases, it may be possible that the system 100 may stop operating close or in resonant mode due to external environment acting on the system 100. In such cases, the system 100 may have a microprocessor and sensors that will act upon the frequency converter 2 to correct the increased frequency AC current based on the data from any component of the system, including the element 4, the circuit 3, frequency converter 2, the first electric wire 8, the first device 16, or other electric components connected to the system 100.

The system 100 may be used to power various devices, such as personal computer (desktops, laptops, netbooks, etc.), a wireless electronic device (a cell phone, a smartphone, a tablet and the like), as well as network equipment (a router, a switch, or a gateway), lighting systems, appliances, change batteries, etc.

The system 100 may comprise hardware and/or software and/or firmware (or a combination thereof) to execute a number of operations that may aid the proper functioning of the system 100.

How the element 4, the circuit 3, the frequency converter 2, the distributive switch 6, the single-wire electric wires, such as the first wire 8, the second wire 11, the third wire 21 or the fourth wire 22, the capacitors 200, 201, or 202, the inductors 203 or 204, or the pluralities of first, second, third, fourth devices, 18, 19, 29 or 30, or the LEDs 20, or other components of the system 100 are implemented is not particularly limited and will depend on how the system 100 is implemented.

It should be expressly understood that implementations of the system 100, element 4, the circuit 3, the frequency converter 2, the distributive switch 6, the single-wire electric wires, such as the first wire 8, the second wire 11, the third wire 21 or the fourth wire 22, the capacitors 200, 201, or 202, the inductors 203 or 204, or the pluralities of first, second, third, fourth devices, 18, 19, 29 or 30, or the LEDs 20 are provided for illustration purposes only. As such, those skilled in the art will easily appreciate other specific implementational details for the system 100, element 4, the circuit 3, the frequency converter 2, the distributive switch 6, the single-wire electric wires, such as the first wire 8, the second wire 11, the third wire 21 or the fourth wire 22, the capacitors 200, 201, or 202, the inductors 203 or 204, or the pluralities of first, second, third, fourth devices, 18, 19, 29 or 30, or the LEDs 20. As such, by no means, examples provided herein above are meant to limit the scope of the present technology.

One skilled in the art will appreciate when the instant description refers to “receiving data” from sensors, executing receiving of the data may receive an electronic (or other) signal from the sensors. One skilled in the art will further appreciate that there may me a step of displaying data to the user via a user-graphical interface (such as the screen of the electronic device and the like) may involve transmitting a signal to the user-graphical interface, the signal containing data, which data can be manipulated and at least a portion of the data can be displayed to the user using the user-graphical interface.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. An electric power system comprising: a power source, a frequency converter conductively connected to the power source, a distributive switch having an input and an output, an element being configured for storing electric energy, a circuit conductively connecting the frequency converter, the element and the distributive switch, a first electric wire having a first end conductively connected to the at least one output, and a second end conductively connected to a first reflective element, a first device conductively connected to the first electric wire between the first end and the second end, a second electric wire having a third end and a fourth end, the third end being conductively connected to the output and the fourth end being conductively connected to the second reflective element, and the frequency converter being configured to transform a current generated by the power source into an increased frequency AC current for powering the first device.

2. The electric power system of claim 1, wherein the first reflective element includes any of an unconnected wire-end of the at least first electric wire, a capacitor, an object comprising a conductive material, a ground, and an insulation of the second end, and the second reflective element includes any of an unconnected wire-end of the at least second electric wire, a capacitor, an object comprising a conductive material, a ground, and an insulation of the fourth end.

3. The electric power system of claim 1, further comprising a second device conductively connected to the second wire between the third end and the fourth end.

4. The electric power system of claim 3, wherein any of the first device and the second device includes any a light source, a sound source, a electromechanical powered device, and a electromagnetically powered device.

5. The electric power system of claim 3, wherein the first device includes a plurality of first devices and the second device includes a plurality of second devices.

6. The electric power system of claim 5, wherein any of the plurality of first devices and the plurality of second devices includes any of light sources, sound sources, electro-mechanical powered devices, and electromagnetically powered devices.

7. The electric power system of claim 5, wherein any of the plurality of first devices and the plurality of second devices includes any of a plurality of light emitting diodes, a plurality of gas lamps, or a plurality of incandescent lamps, a plurality of compact fluorescent lamps, a plurality of halogen lamps, a plurality of metal halide lamps, a plurality of fluorescent tubes, a plurality of neon lamps, a plurality of high intensity discharge lamps, and a plurality of low pressure sodium lamps.

8. The electric power system of claim 5, wherein a first set of the plurality of first devices is conductively connected in a sequence to the first electric wire.

9. The electric power system of claim 5, wherein a second set of the plurality of first devices is conductively connected in parallel to the first electric wire and the second end includes a plurality of second ends.

10. The electric power system of claim 5, wherein a third set of the plurality of first devices includes two light emitting diodes conductively connected to the first electric wire in antiparallel.

11. The electric power system of claim 1, wherein the element includes any of a capacitor and a resonant contour.

12. The electric power system of claim 1, wherein the increased frequency AC current in a range between 1 kilohertz and 1 megahertz.

13. The electric power system of claim 1, wherein the first device is powered when the system is operating close to a resonant mode.

14. The electric power system of claim 1, further comprising a third electric wire conductively connected to the output and a fourth electric wire conductively connected to the output.

15. The electric power system of claim 1, wherein the distributive switch is a transformer.

16. The electric power system of claim 15, wherein the transformer is an impedance-matching transformer.

17. A method of operating an electric power system, the method comprising: receiving a current from a power source, converting the current into an increased frequency AC current, the increased frequency AC current being in a range of 1 kilohertz and 1 megahertz, storing a first portion of an electric energy of the system in a circuit conductively connected to an element, transmitting the increased frequency AC current from the circuit to a first end of a first electric wire, and to a third end of a second electric wire, reflecting a first portion of the increased frequency AC current from a second end of the first electric wire, reflecting a second portion of the increased frequency AC current from a fourth end of the second electric wire, operating the system close to a resonant mode, and powering by the increased frequency AC current a first device, the first device being conductively connected to the first wire between the first end and the second end.

18. The method of operating an electric power system of claim 17, further comprising a step of powering the first device by the first reflected portion of the increased frequency AC current.

19. The method of operating an electric power system of claim 17, wherein converting the current into the increased frequency AC current, includes the steps of determining a resonant frequency of the system, and converting the current from the power source into a resonant frequency AC current, the resonant frequency AC current being within 40% of the resonant frequency of the system.

20. The method of operating an electric power system of claim 17, wherein powering the first device includes powering the first device by a combination of any of a longitudinal current, a standing electromagnetic wave, a travelling electromagnetic wave, a displacement current, recharge current, or electromagnetic vertices.

21. The method of operating an electric power system of claim 17, wherein powering the first device includes powering any of a plurality of light sources, sound sources, electro-mechanical powered devices, or electromagnetically powered devices powering an at least one second device by at least the portion of the increased frequency AC current.

22. The method of operating an electric power system of claim 17, further comprises powering a second device by the increased frequency AC current transmitted via the second electric wire.

23. The method of operating an electric power system of claim 22, further comprises a step of powering the second device by the second reflected portion of the increased frequency AC current.

24. The method of operating an electric power system of claim 17, further comprises the step of setting up the system close to the resonant mode by determining the resonant frequencies of any of the system and the circuit.

25. The method of operating an electric power system of claim 17, further comprises the steps of correcting the increased frequency AC current based on receiving data from any of the element, the circuit, frequency converter, the first electric wire, the first device, and sensors connected to the system.
